(19) United States
(12) Patent Application Publication
(10) Pub. No.: US 2016/0099617 A1
(43) Pub. Date: Apr. 7, 2016

(54) AIR-COOLED ELECTRIC MACHINE HAVING COOLING RIBS FORMED FROM STATOR SHEET

(71) Applicant: SIEMENS AKTIENGESELLSCHAFT, 80333 München (DE)

(72) Inventors: MARCO KÖHLER, Neunkirchen am Sand (DE); GERHARD GÖMMEL, Postbauer-Heng (DE); FREERK JACOBUS OUDE KOTTE, Nürnberg (DE); THOMAS RETTIG, Erlangen (DE)

(73) Assignee: SIEMENS AKTIENGESELLSCHAFT, 80333 München (DE)

(21) Appl. No.: 14/893,456

(22) PCT Filed: May 5, 2014
(86) PCT No.: PCT/EP2014/059081

§ 371 Date: Nov. 23, 2015

(30) Foreign Application Priority Data
May 24, 2013 (EP) 13169135.4

(51) Int. Cl. H02K 1/18

(52) U.S. Cl. CPC H02K 1/185

(57) ABSTRACT

An electric machine has rotor rotatably supported in bearings for rotation about an axis of rotation, a stator surrounding the rotor with respect to the axis of rotation and having stator sheets, which are stacked in the direction of the axis of rotation. The stator sheets have a number of recesses which form grooves extending parallel to the axis of rotation. Tension strips are arranged in the grooves and connected to end rings. The stator sheets include at least first stator sheets. The first stator sheets each have at least one large lug. Between the two tension strips adjacent to the respective large lug in a circumferential direction about the axis of rotation, the large lug protrudes radially outward beyond the two adjacent tension strips. The large lug has cantilevers extending about the axis of rotation and reaching over the two adjacent tension strips.

The present invention relates to an electric machine,
wherein the electric machine has a rotor, which is rotatably supported in bearings, so that the rotor is able to be rotated about an axis of rotation,
wherein the electric machine has a stator, which surrounds the rotor radially on the outside with respect to the axis of rotation,
wherein the stator consists of stator sheets, which are stacked one on the other in the direction of the axis of rotation.

Such electric machines are generally known. In particular almost any rotational electric machine of which the rotor is embodied as an internal armature is constructed in this way.

The present invention further relates to a land vehicle,
wherein the land vehicle has drive wheels,
wherein a rotor of an electric machine acts on at least one of the drive wheels,
wherein an axis of rotation of the rotor runs transverse to a direction of travel of the land vehicle.

Such land vehicles are also generally known—especially as rail vehicles.

Direct drives are often used in land vehicles, where said vehicles are driven by electric machines. Because of the low rotational speeds of a direct drive and often the lack of installation space, separate fans cannot be used for cooling. Although water cooling is possible, this results in additional costs. It is therefore known in the prior art to surround the stator with a cast housing, which in its turn has cooling ribs. The heat losses arising in the stator are passed on to the housing and discharged there to the environment by wind when the vehicle is moving, by convection and by radiation. A problem of this type of construction is that a low heat transfer resistance from the stator to the cast housing must be guaranteed. The seating must therefore be designed with care. The wall thickness of the housing is correspondingly large. Because of aspects of casting technology the cooling ribs cannot be less than a minimum thickness. This makes the cooling ribs relatively thick and heavy. In addition the realizable surface of the cooling ribs is restricted.

Electric machines without housings are also known in the prior art. With electric machines of this type massive tension strips are often arranged on the outside of the stator. The tension strips cover the stator sheets and often also cover any cooling ribs present to a significant extent. They therefore adversely affect the cooling.

The object of the present invention consists of creating opportunities to efficiently air-cool an electric motor without a housing.

The object is achieved by an electric machine with the features of claim 1. Advantageous embodiments of the inventive electric machine are the subject matter of dependent claims 2 to 13.

In accordance with the invention an electric machine of the type described at the start is further developed such that,
the stator sheets, with respect to the axis of rotation, have a number of recesses radially on the outside which, in the totality thereof, form grooves running in parallel to the axis of rotation,
tension strips, which are connected at their ends by end rings, are arranged in the grooves,
the stator sheets at least comprise first stator sheets and
the first stator sheets each have at least one large lug, which projects radially outwards between the two tension strips adjacent to the large lug in the circumferential direction about the axis of rotation over the two adjacent tension strips and has cantilevers extending there about the axis of rotation which reach over the two adjacent tension strips.

On the one hand this makes it possible, by means of the first stator sheets, to realize cooling ribs which, viewed radially with respect to the axis of rotation, project beyond the tension strips. On the other hand the tension strips are fixed in the axial direction by the cantilevers. If bending torque acts on the electric machine, the tension strips thus cannot lift away from the stator. This means that—unlike in the prior art—all tension strips accept a part of the bending torque. The bending torque to be accepted by an individual tension strip is consequently lower than in the prior art. The tension strips can therefore be dimensioned smaller.

In a preferred embodiment of the electric machine there is provision for the first stator sheets to additionally have further lugs, which project radially outwards between the two tension strips adjacent to the further lugs in the circumferential direction about the axis of rotation. A more flexible design of the cooling ribs is produced by this embodiment.

Preferably there is provision for at least one of the further lugs to project radially outwards beyond the two respective adjacent tension strips. These further lugs—in a similar way to the large lug—can, but do not have to, have cantilevers that extend about the axis of rotation and reach over the two adjacent tension strips. As an alternative or in addition it is possible for the further lugs of the first stator sheets to extend radially outwards by different widths. These embodiments enable the structure of the cooling ribs to be aligned for optimum heat dissipation.

The number of tension strips can be determined as required. It is especially preferred for the number to amount to six. In particular such stator sheets can be used as a rule, independently of the number of stator grooves, for any electric machine fed with alternating current.

Even in the case in which the stator sheets exclusively comprise the first stator sheets, a plurality of designs of the electric machine with highly-efficient cooling is possible. Preferably however there is provision
for the stator sheets to have second stator sheets in addition to the first stator sheets,
for the second stator sheets each to have a number of lugs which each project radially outwards between the two tension strips adjacent to the large lug viewed in the circumferential direction about the axis of rotation over the two adjacent tension strips,
for the lugs of the second stator sheets not to project radially outwards as far as the large lugs of the first stator sheets and not to have any cantilevers extending about the axis of rotation which reach over the two respective adjacent tension strips.

The presence of the second stator sheets as well makes possible a much greater flexibility in the design of the cooling ribs. In particular it is possible to flexibly set a distance that the large lugs which are arranged in the circumferential direction about the axis of rotation at the same tangential position have from one another.

It has proved advantageous for the lugs of the second stator sheets to project radially outwards to different widths.

As a general rule the number of lugs of the second stator sheets is equal to the number of lugs of the first stator sheets.

A very sufficient flexibility in the design of the stator is produced by means of the first and the second stator sheets as a general rule. It is thus possible for the stator sheets not to include any further stator sheets.

The cross section of the tension strips can be determined as required. Preferably the tension strips have a rectangular or trapezoidal cross section. This makes possible a relatively light and stable, but low-cost, construction. This is quite especially true if, with respect to the axis of rotation, the wide sides of the rectangular cross section or the parallel sides of the trapezoidal cross section are aligned in the circumferential direction, the other sides being aligned radially.

Preferably there is provision for the stator sheets to be grouped together into groups of immediately adjacent stator sheets, in the direction of the axis of rotation, wherein the groups each have a uniform group contour and the group contour varies from group of stator sheets to group of stator sheets. This guarantees a good cooling effect with good mechanical stability of the lugs, without having a negative effect on the electrical characteristics of the electric machine.

The number of stator sheets per group can be determined as required. As a rule the number of stator sheets per group lies between 4 and 10. In the same way a thickness of the group, viewed in the direction of the axis of rotation, can be determined as required. As a rule the thickness lies between 2.5 mm and 6.0 mm, for example between 3.5 mm and 5.0 mm.

In an especially preferred embodiment of the present invention there is provision that, in the direction of the axis of rotation, the groups of stator sheets in the middle follow each other in a first sequence and in the two edge areas adjacent to the middle follow each other in a second sequence different from the first sequence. This makes it possible to optimize the electric machine in the middle in a different way from at the edges.

The object is further achieved by a land vehicle with the features of claim 14. Advantageous embodiments of the inventive land vehicle are the subject matter of dependent claims 15 and 16.

In accordance with the invention a land vehicle of the type described at the start is further embodied by
the electric machine being embodied as an inventive electric machine and
the large lugs of the first stator sheets being arranged such that they do not project downwards.

Through this embodiment a good cooling effect can be obtained even if no cooling ribs can be arranged in the lower area for reasons of lack of ground clearance.

Depending on requirement, it is possible for the large lugs or the first stator sheets to be arranged such that they do not project upwards either. This embodiment enables the vertical height of the electric machine to be minimized.

The land vehicle can be embodied as required. In particular however it is possible for the drive wheels to be embodied as the running wheels of a rail vehicle. In this case the land vehicle is especially used in short-range public transportation. For example the land vehicle can be embodied as a subway train or a streetcar.

The characteristics, features and advantages of this invention explained above, as well as the way in which these are achieved, will become clearer and more easy to understand in conjunction with the description given below of the exemplary embodiments, which are explained in greater detail in conjunction with the drawings in which, in schematic diagrams:

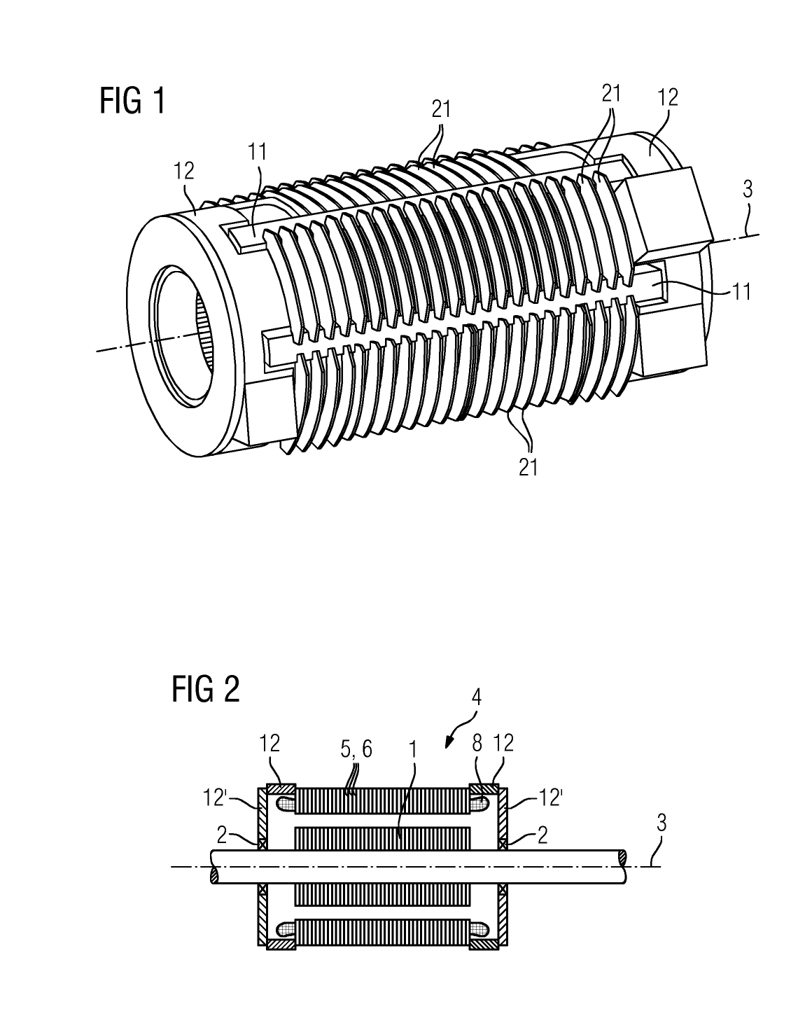

FIG. 1 shows an electric machine in a perspective view;

FIG. 2 shows a longitudinal section through the electric machine from FIG. 1;

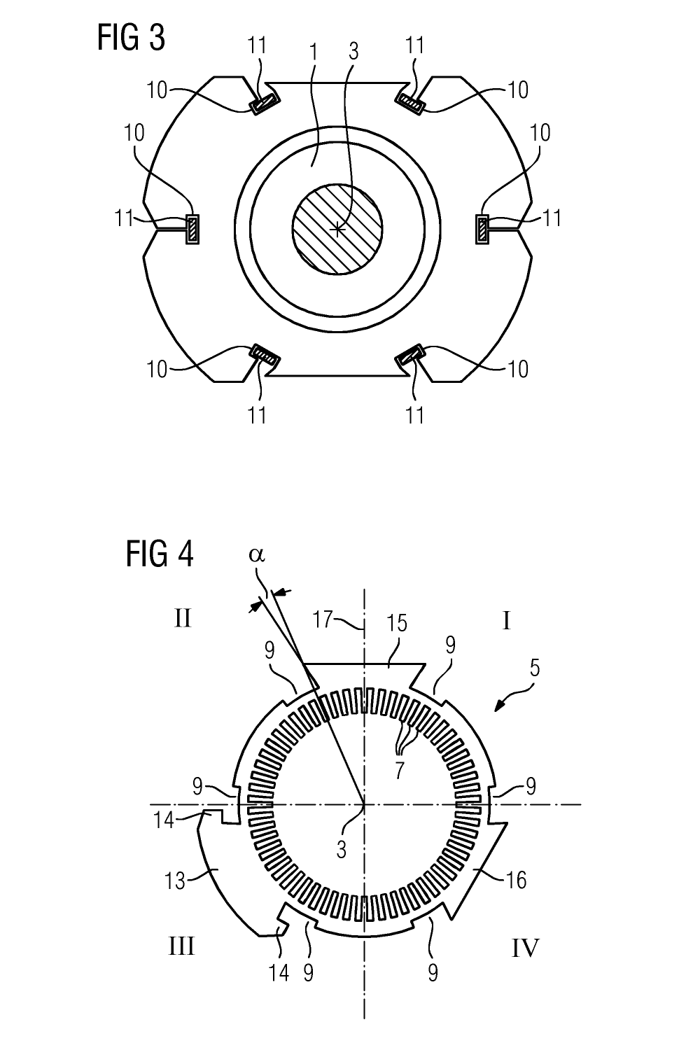

FIG. 3 shows a cross section through the electric machine from FIG. 1;

FIG. 4 shows an individual: first stator sheet;

FIG. 5 shows an individual second stator sheet;

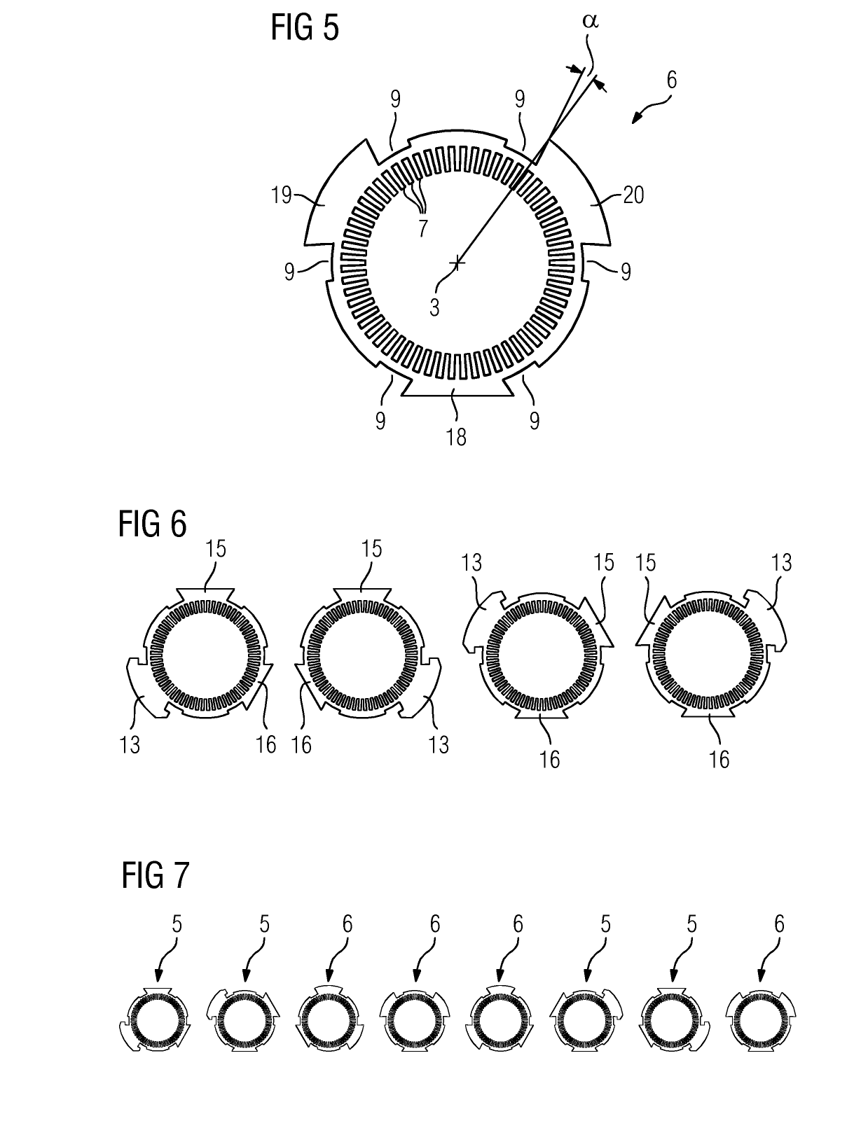

FIG. 6 shows possible orientations of first stator sheets;

FIG. 7 shows a possible first sequence of first and second stator sheets;

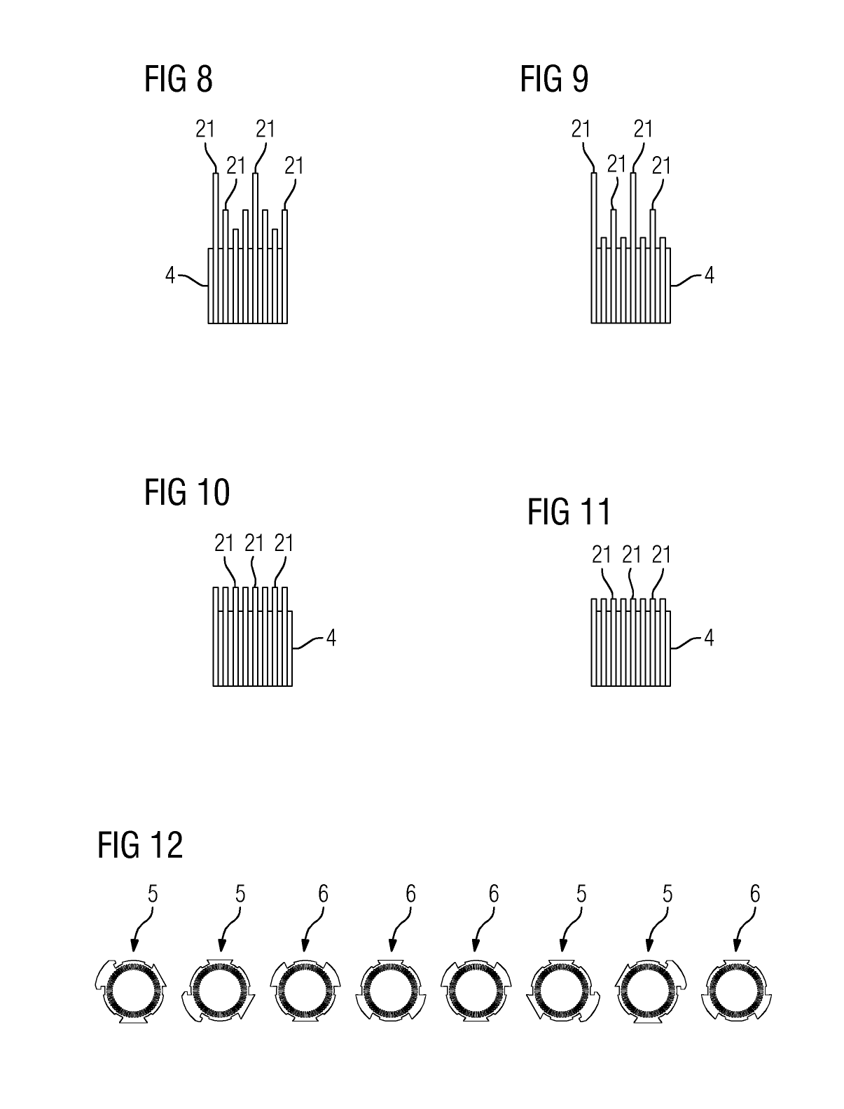

FIGS. 8 to 11 show associated geometries of cooling ribs;

FIG. 12 shows a possible second sequence of first and second stator sheets;

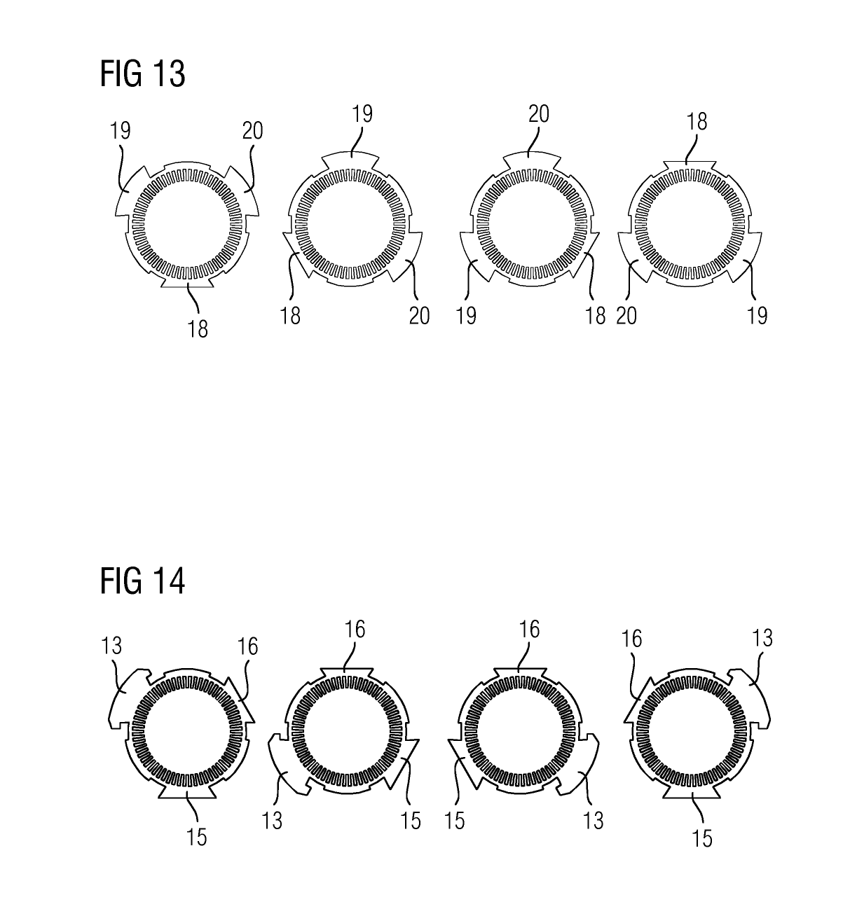

FIG. 13 shows possible orientations of second stator sheets;

FIG. 14 shows further possible orientations of first stator sheets;

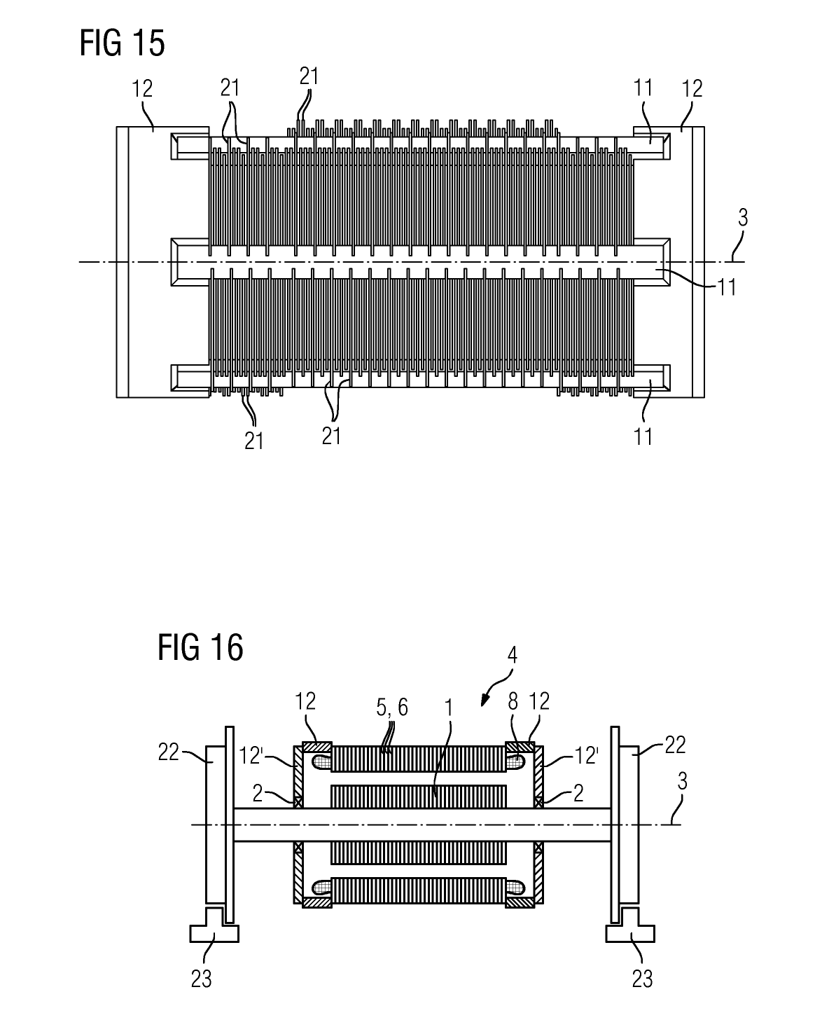

FIG. 15 shows a side view of an electric machine; and

FIG. 16 shows a land vehicle.

In accordance with FIGS. 1 to 3 an electric machine has a rotor 1. The rotor 1 is rotatably supported in bearings 2. The rotor 1 is thereby able to be rotated about an axis of rotation 3.

Where the terms “axial”, “radial” and “tangential” are used below, they are always related to the axis of rotation 3. Axial is a direction which is aligned in parallel to the axis of rotation 3. Radial is a direction which runs orthogonally to the axis of rotation 3, meaning directly towards or away from the axis of rotation 3. Tangential is a direction which is orthogonal both to the axial direction and also to the radial direction. Tangential is thus a direction which is aligned at a constant radial distance from the axis of rotation 3 in a circular shape about the axis of rotation 3.

The electric machine further has a stator 4. The stator 4 surrounds the rotor 1 radially on the outside. The stator 4 consists of stator sheets 5, 6. The stator sheets 5, 6, viewed in the axial direction, are stacked one on the other. In accordance with FIGS. 4 and 5, on their side facing towards the rotor 1 (i.e. radially inwards) the stator sheets have teeth 7 which project towards the rotor 1. Arranged between the teeth 7 is a stator winding 8. In FIG. 2 only the winding heads of the stator winding 8 are visible. On their radially outer side the stator sheets 5, 6 have a number of recesses 9. In the totality thereof (i.e. viewed axially over the entire length of the stator 4) the recesses 9 form grooves 10 running axially. Tension strips 11 are arranged in the grooves 10. The tension strips 11 are connected at their ends with end rings 12. The stator 4 is held together by means of the tension strips 11 and the end rings 12. The tension strips 11 and the end rings 12 can be connected to each other as required. For example the tension strips 11 can be welded to the end rings 12. The tension strips 11 preferably have a rectangular or trapezoidal cross section. As a rule bearing shields 12′, in which the bearings 2 are arranged, are usually placed on the axial outer side of the end rings 12.

The stator sheets 5, 6 comprise at least first stator sheets 5. The first stator sheets 5 have the same cut sheet shape as each other. A single first stator sheet 5 is shown in FIG. 4. According to FIG. 4 the first stator sheet 5 depicted has a large lug 13. The large lug 13 extends in the tangential direction between the two tangentially adjacent tension strips 11. The large lug 13 projects radially outwards beyond these two tension strips 11. In the area projecting beyond these two tension strips 11, the large lug 13 has cantilevers 14 which extend tangentially and reach radially outwards over these two tension strips 11.

According to FIG. 4 the first stator sheets 5 each have a single large lug 13. In many cases however it can be sensible for the first stator sheets 5 to have more than one large lug 13. In many embodiments of the electric machine it is further sufficient for the first stator sheets 5 to have exclusively the large lug 13 or the large lugs 13, but not to have any further lugs 15, 16. Often however these further lugs 15, 16 are present. In this case the further lugs 15, 16 extend in the tangential direction between the two respective tangentially adjacent tension strips 11, but not as far as the large lug 13 or the large lugs 13. Furthermore the further lugs 15, 16 also project radially outwards between the two respective adjacent tension strips 11 In accordance with FIG. 4 the further lugs 15, 16—by contrast with the large lug 13—do not have any cantilevers which reach radially outwards over the two respective adjacent tension strips 11. Furthermore the further lugs 15, 16, with respect to the axis of rotation 3, are preferably delimited radially outwards by secants. This contrasts with the large lug 13, which, with respect to the axis of rotation 3, is preferably delimited radially outwards (possibly with the exception of its tangential end areas) by the arc of a circle. Depending on the individual situation the further lugs 15, 16 can be delimited radially outwards by the arc of a circle as an alternative to a secant.

It is possible for the further lugs 15, 16 of the first stator sheets 5, viewed in the radial direction, not to project radially outwards beyond the two respective adjacent tension strips 11. As an alternative it is possible for at least one of the further lugs 15, 16, viewed in the radial direction, to project radially outwards beyond the two respective adjacent tension strips 11. In this case the corresponding further lugs 15, 16 can have cantilevers in a similar way to the large lug 13. It is further possible for the further lugs 15, 16 of the first stator sheet 5 to project equally far radially outwards. Preferably the further lugs 15, 16 of the first stator sheet 5, as shown in the diagram of FIG. 4, project radially outwards for different widths.

In accordance with FIG. 4 the further lugs 15, 16 run in the tangential direction, viewed about the axis of rotation 3, slightly conically. The edges thus form an angle α with the radial direction which, although it is small, is different from 0. The angle α can lie between 2° and 5° for example. Because of the angle α the recesses 9 adjacent to the further lugs 15, 16 can have a parallel cross section radially outwards or can narrow. As an alternative the edges of the further lugs 15, 16 can run purely radially. The edges of the large lug 13—regardless of whether the edges of the further lugs 15, 16 run purely radially or slightly conically—preferably has the same course as the edges of the further lugs 15, 16. With respect to the large lug 13, the same conicity can—but does not have to—exist.

According to FIG. 4 the number of tension strips 11 amounts to six. This is a preferred embodiment. Embodiments with more or less than six tension strips 11 are also possible however.

It is possible for the stator sheets 5, 6 to include exclusively the first stator sheets 5, but no further stator sheets. In this case the first stator sheets 5 can be stacked for example in a way explained below in greater detail in conjunction with FIG. 6.

As depicted in FIG. 6, the first stator sheets 5 are stacked in four different orientations, namely
In a basic orientation, which is shown on the left in FIG. 6 and also in FIG. 4;

In a first singly-rotated orientation, in which the corresponding first stator sheet 5, with respect to the basic orientation, is rotated by 180° about a vertical axis 17 (see FIG. 4); this position is shown on the right in FIG. 6 next to the first singly-rotated orientation;
In a second singly-rotated orientation, in which the corresponding first stator sheet 5, with respect to the basic orientation, is rotated by 60° in the clockwise direction about the axis of rotation 3; this position is shown on the right in FIG. 6 next to the first singly-rotated orientation;
In a doubly-rotated orientation, in which the corresponding first stator sheet 5, with respect to the basic orientation, is first rotated by 60° in the clockwise direction about the axis of rotation 3 and is then rotated by 180° about a vertical axis 17; this position is shown on the far right in FIG. 6.

The sequence in which the orientations follow one another can be determined as required. In the simplest case the order is basic orientation—first singly-rotated orientation—second singly-rotated orientation—doubly-rotated orientation. As an alternative the order basic orientation—second singly-rotated orientation—first singly-rotated orientation—doubly-rotated orientation is possible for example. Depending on the individual situation, other orders and also other orientations of the first stator sheets 5 are possible.

As a rule the stator sheets 5, 6 (viewed in the axial direction) have a relatively small thickness. Mostly the thickness of an individual stator sheet 5, 6 is less than 1 mm. To increase the stability, especially of the large lugs 13, the first stator sheets 5 are mostly collected into groups as part of the stacking. Thus a number of first stator sheets 5 in each case, which follow on immediately from one another in the axial direction, have the same orientation and thus also the same contour—referred to below as the group contour. However the group contour varies in each case from group to group of first stator sheets 5. The orientations mentioned above in connection with FIG. 6 (or also other orientations) thus preferably do not apply for a single first stator sheet 5, but for the respective group of first stator sheets 5.

The number of first stator sheets 5 per group can be determined as required. As a rule it lies between four and ten, for example five to eight. In particular it can be about six. Because of the group formation the groups (in the axial direction) have a greater thickness than a single first stator sheet 5. The thickness of the groups lies as a rule between 2.5 mm and 6.0 mm, for example between 3.0 mm and 5.0 mm. In particular it can lie between 3.5 mm and 4.0 mm.

It is possible for no other stator sheets 5, 6 to be present apart from the first stator sheets 5. Preferably however the stator sheets 5, 6 include second stator sheets 6 in addition to the first stator sheets 5. The second stator sheets 6 have the same cut sheet shape as each other. A single second stator sheet 6 is shown in FIG. 5. According to FIG. 5 the second stator sheet 6 has a number of lugs 18, 19, 20. The lugs 18, 19, 20 of the second stator sheet 6 extend in the tangential direction between the two tangentially-adjacent tension strips 11 in each case. Furthermore the lugs 18, 19, 20 of the second stator sheet 6 also project radially outwards between the two adjacent tension strips 11 in each case. The lugs 18, 19, 20 of the second stator sheet 6 do not however project as far radially outwards as the large lugs 13 of the first stator sheets 5. Also the lugs 18, 19, 20 of the second stator sheet 6—in a similar way to the further lugs 15, 16 of the first stator sheets 5—do not have any cantilevers which reach over the two adjacent tension strips 11 in each case.

In accordance with FIG. 5 the number of lugs 18, 19, 20 of the second stator sheet 6 amounts to three. The number of lugs 18, 19, 20 of the second stator sheet 6 is thus equal to the number of lugs 13, 15, 16 of the first stator sheet 5. This embodiment is produced as a rule—but does not absolutely have to be.

It is possible for the lugs 18, 19, 20 of the second stator sheet 6 to all be the same size. Preferably however the lugs 18, 19, 20 of the second stator sheet 6 protrude radially outwards to different widths. Although a few of the lugs 18, 19, 20 of the second stator sheet 6 can have a uniform radial extent, at least one of the lugs 18, 19, 20 of the second stator sheet 6 is however larger or—as shown in FIG. 5—smaller than the other lugs 19, 20 of the second stator sheet 6. The smaller of the lugs 18, 19, 20 of the second stator sheets 6—with respect to the axis of rotation 3—are preferably delimited radially outwards by secants. This is by contrast with the larger of the lugs 18, 19, 20 of the second stator sheets 6, which—with respect to the axis of rotation 3—are preferably delimited radially outwards by the arc of a circle. Depending on the individual situation, the smaller of the lugs 18, 19, 20 can likewise be delimited radially outwards, as an alternative to a secant, by the arc of a circle.

It is possible that the lugs 18, 19, 20 of the second stator sheet 6, viewed in the radial direction, do not project radially outwards beyond the adjacent tension strips 11 in each case. As an alternative it is possible that at least one of the lugs 18, 19, 20 of the second stator sheet 6, viewed in the radial direction, does project radially outwards beyond the adjacent tension strips 11 in each case.

According to FIG. 5 the lugs 18, 19, 20 of the second stator sheet 6—in a similar way to the further lugs 15, 16 of the first stator sheets 5—run slightly conically—viewed in the tangential direction about the axis of rotation 3. The edges thus form the angle α with the radial direction. Because of the angle α the recesses 9 adjacent to the lugs 18, 19, 20 of the second stator sheet 6 narrow radially outwards or have a parallel cross section. As an alternative the edges of the lugs 18, 19, 20 of the second stator sheets can run purely radially, in a similar way to the further lugs 15, 16 of the first stator sheet 5.

In particular if the stator sheets 5, 6 include both the first stator sheets 5 and also the second stator sheets 6, it is not necessary for the stator sheets 5, 6 to include further stator sheets. This is because the presence of the first and also the second stator sheets 5, 6 gives great flexibility in the design of cooling ribs 21. A first possible sequence of first and second stator sheets 5, 6 is explained below, initially in conjunction with FIGS. 7 to 11, then a second possible sequence of first and second stator sheets 5, 6 is explained in conjunction with FIG. 12. Regardless of whether one of the two sequences explained in conjunction with FIGS. 7 to 12 or another sequence is realized, it is also true to say that, for the sequences of first and second stator sheets 5, 6—as it was previously for sequences of (exclusively) first stator sheets 5—to increase the stability of the cooling ribs 21 formed, the first and second stator sheets 5, 6 are mostly grouped into groups as part of the stacking process. What has been said above about forming groups including the preferred number of stator sheets 5, 6 and about the preferred thickness of the formed groups therefore also applies to the embodiments described in conjunction with FIGS. 7 to 12.

Within the context of FIGS. 7 to 11, with respect to the first stator sheets 5, the orientation already explained, given above in connection with FIG. 4 (basic orientation—first singly-rotated orientation—second singly-rotated orientation—doubly-rotated orientation) is needed. With respect to the second stator sheets 6 three orientations are needed, which are shown in FIG. 13 and are referred to below as basic orientation, as first rotated orientation and as second rotated orientation.
In the basic orientation, which is shown in FIG. 13 on the left and also in FIG. 6, the small lug 18 of the second stator sheet 6 points downwards.
In the first rotated orientation the corresponding second stator sheet 6 is rotated by 60° in the clockwise direction about the axis of rotation 3 with respect to the basic orientation. This orientation is shown on the right in FIG. 13 next to the first rotated orientation.
In the first rotated orientation the corresponding second stator sheet 6 is rotated by 60° in the counterclockwise direction about the axis of rotation 3 with respect to the basic orientation. This orientation is shown on the right in FIG. 13 next to the first rotated orientation.

FIG. 7 shows the order of first and second stator sheets 5, 6 in accordance with the first sequence. The first and second stator sheets 5, 6 (or the corresponding groups) follow on from one another in accordance with the sequence of orientations given below
First stator sheet 5 in the basic orientation,
First stator sheet 5 in the second singly-rotated orientation,
Second stator sheet 6 in the first rotated orientation,
Second stator sheet 6 in basic orientation,
Second stator sheet 6 in the second rotated orientation,
First stator sheet 5 in the doubly-rotated orientation,
First stator sheet 5 in the first singly-rotated orientation,
Second stator sheet 6 in the basic orientation,

With this sequence of first and second stator sheets 5, 6 a pattern of cooling ribs 21 as shown in FIG. 8 is formed, with respect to the coordinate cross shown in FIG. 4, in the two quadrants identified by I and II. In the quadrants identified by III and IV a pattern of cooling ribs 21 as shown in FIG. 9 is formed. In the transition area from quadrant Ito quadrant II a pattern of cooling ribs 21 as shown in FIG. 10 is formed. In the transition area from quadrant III to quadrant IV a pattern of cooling ribs 21 as shown in FIG. 11 is formed.

For the order of first and second stator sheets 5, 6 in accordance with the second sequence, four further orientations of the first stator sheet 5 are needed. These orientations are shown in FIG. 14 and, based on the basic orientation of the first stator sheet 5 already explained, are designated and defined as follows;
Orientation A: The first stator sheet 5 is rotated both about the axis of rotation 3 and also about the vertical axis 17, by 180° in each case. The sequence of the two rotations is irrelevant. This orientation is shown to the outside on the left in FIG. 14.
Orientation B: The first stator sheet 5 is initially rotated by 180° about the vertical axis 17, then by 120° in the counterclockwise direction about the axis of rotation 3. This orientation is shown as the second from the left in FIG. 14.
Orientation C: The first stator sheet 5 is rotated counterclockwise by 120° about the axis of rotation 3. This orientation is shown as the third from the left in FIG. 14.
Orientation D: The first stator sheet 5 is rotated counterclockwise by 180° about the axis of rotation 3. This orientation is shown to the outside on the right in FIG. 14.

Furthermore an additional orientation of the second stator sheets 6 is needed, referred to below as the third rotated orientation. In the third rotated orientation the corresponding second stator sheet 6 is rotated by 180° about the axis of rotation 3 with respect to the basic orientation. This orientation is shown to the outside on the right in FIG. 13.

As part of the sequence of FIG. 12 the first and second stator sheets 5, 6 (or the corresponding groups) follow on from one another as explained below:
First stator sheet 5 in the orientation A,
First stator sheet 5 in the orientation B,
Second stator sheet 6 in the basic orientation,
Second stator sheet 6 in the third rotated orientation,
Second stator sheet 6 in the basic orientation,
First stator sheet 5 in the orientation C,
First stator sheet 5 in the orientation D,
Second stator sheet 6 in the third rotated orientation,

With this sequence of first and second stator sheets 5, 6 another pattern of cooling ribs 21 is formed. Both in the sequence in accordance with FIG. 7 and also in the sequence in accordance with FIG. 12 however no large lugs 13 of the first stator sheets 5 are arranged either at the top (i.e. in the transition area from quadrant I to quadrant II) or also at the bottom (i.e. in the transition area from quadrant II to quadrant IV).

In many cases it will suffice, within the context of the stacking of first and second stator sheets 5, 6, to use the stacking exclusively in accordance with FIG. 7 or exclusively in accordance with FIG. 12. In some cases however it can be sensible, in accordance with FIG. 15, viewed in the axial direction, in the middle of the electric machine on one side and in edge areas adjoining the middle on both sides, to let different sequences follow on from one another. For example the first sequence, explained above in conjunction with FIG, 7, can be used in the middle, the sequence explained above in conjunction with FIG. 12 can be used in the edge areas. The edge areas, viewed in the axial direction, can extend as required—for example in each case over the outer 10% to 25% of the length of the stator 4.

In its approach, the inventive electric machine is universally applicable. For example it can be used according to the diagram shown in FIG. 16 for driving a land vehicle. In this case the land vehicle has drive wheels 22, wherein the rotor 1 of the inventive electric machine acts on at least one—under some circumstances also on two—of the drive wheels. The rotor 1 can especially act directly (i.e. without intermediate gearing) on the at least one drive wheel 22. In accordance with the diagram in FIG. 14 the axis of rotation 3 runs, transverse to a direction of travel of the land vehicle. As a rule the axis of rotation 3 further runs in parallel to the subfloor of the land vehicle, thus mostly horizontal. In particular the large lugs 13 of the first stator sheets 5 are preferably oriented in the electric machine used in the land vehicle as has been explained above in connection FIGS. 6, 7 and 12. The large lugs 13 of the first stator sheet 5 thus especially do not project upwards and downwards. Under some circumstances a sequence of first stator sheets 5 or of first stator sheets 5 and second stator sheets 6 can be selected, in which the large lugs 13 of the first stator sheets 5 project upwards. However the large lugs 13 of the first stator sheets 5 should at least not project downwards.

Otherwise the land vehicle can be embodied as required, for example as an electric automobile. Preferably the land vehicle is embodied as a rail vehicle however. The drive wheels 22 are therefore preferably embodied as running wheels of a rail vehicle, which roll on rails 23 during operation of the rail vehicle.

The present invention has many advantages. In particular an easy-to-cool, mechanically-stable electric machine, which has a relatively low weight, can be created in a simple manner. The surface of the cooling ribs 21 can be maximized. The punching costs and the tool costs are barely increased by comparison with conventional electric machines, since only two different stator sheets 5, 6 are needed, even in the most unfavorable case. The available space can be well utilized. The sequence of the cooling ribs 21 and their axial spacing from one another—especially in conjunction with the two sequences explained in conjunction with FIGS. 7 and 12—can be designed so that an efficient cooling is possible, both when stationary by convection and also by wind when moving.

Significant improvements are able to be achieved compared to an electric machine with a cast housing. Thus for example a surface greater by about 50% can be realized. Furthermore an overall resulting saving in weight of about 10% can be achieved. Furthermore there is no heat transfer resistance between stator 4 and cast housing. The length of the electric machine (in the axial direction) could be reduced in the radial direction by about 13%, with the dimensions remaining unchanged. Also a rise in temperature during operation reduced by about 10% could be achieved.

Although the invention has been illustrated in greater detail and described by the preferred embodiment, the invention is not restricted by the disclosed examples and other variations can be derived herefrom by the person skilled in the art, without departing from the scope of protection of the invention.

1.-16. (canceled)

17. An electric machine, comprising:
a rotor supported in bearings for rotation about an axis of rotation;
a stator arranged in radial surrounding relationship with respect to the axis of rotation and including stator sheets which are stacked upon one another in a direction of the axis of rotation, said stator sheets having a number of recesses radially outside with respect to the axis of rotation to form grooves in parallel relationship to the axis of rotation;
tension strips arranged in the grooves and having ends; and
end rings connected at the ends of the tension strips,
wherein a first plurality of the stator sheets have each at least one first lug configured to project radially outwards between two of the tension strips adjacent to the first lug as viewed in a circumferential direction about the axis of rotation over the two adjacent tension strips, said first lug having cantilevers configured to extend about the axis of rotation and sized to reach over the two adjacent tension strips.

18. The electric machine of claim 17, wherein the first plurality of stator sheets have second lugs configured to respectively project radially outwards between two of the tension strips adjacent to the second lugs as viewed in the circumferential direction about the axis of rotation.

19. The electric machine of claim 18, wherein the second lugs are sized to extend radially outwards beyond the two adjacent tension strips.

20. The electric machine of claim 18, wherein the second lugs of the first plurality of stator sheets extend radially outwards by different distances.

21. The electric machine of claim 17, wherein six of the tension strips are provided.

22. The electric machine of claim 18, wherein the second lugs are sized more shallow than the first lug.

23. The electric machine of claim 17, wherein the stator sheets include a second plurality of stator sheets having each plural lugs, each lug of the second plurality of stator sheets being sized to project radially outwards between two of the tension strips adjacent to the lug as viewed in the circumferential direction about the axis of rotation beyond the two adjacent tension strips, said lugs of the second stator sheets being sized more shallow that the first lug of the first plurality of stator sheets in the absence of any cantilever extending about the axis of rotation and reaching over the tension strips.

24. The electric machine of claim 23, wherein the lugs of the second plurality of stator sheets are sized to project radially outwards to different distances,

25. The electric machine of claim 18, wherein a number of lugs of the second plurality of stator sheets is equal to a number of first and second lugs of the first plurality of stator sheets.

26. The electric machine of claim 17, wherein the stator sheets do not include any further stator sheets.

27. The electric machine of claim 17, wherein the tension strips have a rectangular or trapezoidal cross section.

28. The electric machine of claim 17, wherein the stator sheets are grouped into groups of directly consecutive stator sheets viewed in the direction of the axis of rotation, each said group having a uniform group contour, with the group contour varying from one of the groups of stator sheets to another one of the groups of stator sheets.

29. The electric machine of claim 28, wherein a number of stator sheets per group is between 4 and 10 and/or a thickness of the groups, viewed in the direction of the axis of rotation, is between 2.5 mm and 6.0 mm.

30. The electric machine of claim 28, wherein, viewed in the direction of the axis of rotation, the groups of stator sheets in the middle follow each other in a first sequence and, in edge areas adjacent to the middle on both sides, follow each other in a second sequence different from the first sequence.

31. A land vehicle, comprising:
drive wheels; and
an electric machine including a rotor operatively connected to at least one of the drive wheels and supported in bearings for rotation about an axis of rotation which extends transverse to a direction of travel of the land vehicle, a stator arranged in radial surrounding relationship with respect to the axis of rotation and including stator sheets which are stacked upon one another in a direction of the axis of rotation, said stator sheets having a number of recesses radially outside with respect to the axis of rotation to form grooves in parallel relationship to the axis of rotation, tension strips arranged in the grooves and having ends, and end rings connected at the ends of the tension strips,
wherein a first plurality of the stator sheets have each at least one lug configured to project radially outwards between two of the tension strips adjacent to the lug as viewed in a circumferential direction about the axis of rotation over the two adjacent tension strips, said lug configured without projecting downwards and having cantilevers configured to extend about the axis of rotation and sized to reach over the two adjacent tension strips.

32. The land vehicle of claim 31, wherein the lug is configured without projecting upwards.

33. The land vehicle of claim 31, wherein the drive wheels are embodied as running wheels of a rail vehicle.
